(19) United States
(12) Patent Application Publication
(10) Pub. No.: US 2015/0095397 A1
(43) Pub. Date: Apr. 2, 2015

(54) INTEGRATED SYSTEMS FOR USE IN INTERVENTIONAL PROCEDURES

(71) Applicant: General Electric Company, Schenectady, NY (US)

(72) Inventors: Jeffrey Wayne Eberhard, Albany, NY (US); James Vradenburg Miller, Schenectady, NY (US); Joseph John Manak, Albany, NY (US)

(73) Assignee: General Electric Company, Schenectady, NY (US)

(21) Appl. No.: 14/042,045

(22) Filed: Sep. 30, 2013

(51) Int. Cl. G06F 19/00

(52) U.S. Cl. CPC G06F 19/32
USPC 709/200

(57) ABSTRACT

The present disclosure relates to the use of integrated or consolidated systems for use in interventional systems. By way of example, in a procedure room a single console or platform may be provided (as opposed to multiple stand-alone platforms) having interventional tools (such as imaging, monitoring, or navigational tools) for use with a patient in the procedure room. Other components of the systems may be provided at different locations, such as in a technical or control room, depending on their function and/or whether the components need to be in a particular location, such as proximate to the patient or to a user.

### BACKGROUND

The subject matter disclosed herein relates to interventional procedures and the equipment used in such procedures.

As medical technologies have matured, it has become possible to perform various surgical or interventional procedures in a minimally invasive manner. For example, minimally invasive procedures, such as certain surgical or interventional procedures, may utilize computer-assisted imaging and navigation techniques that allow a clinician to visualize the internal or obscured structures in the surgical area while the procedure is being performed. In this way, the clinician may perform the desired surgical or interventional procedure with a greater chance of success while minimizing or reducing tissue damage.

In practice, modern interventional medical procedures may bring together a wide variety of monitoring, imaging, and therapy devices to provide the functionality needed to carry out these complex interventional and surgical medical tasks. As a result, today's procedure rooms may contain a large number and variety of nominally free-standing systems that are brought together to meet the specific needs of a particular procedure. However, the user interactions with the various systems may only be lightly integrated, if at all. It is typically left to the operators (e.g., interventional physicians and support staff) to effectively integrate the information in their heads, which results in incomplete integration, lost information, repeat acquisitions to make needed information available again, longer exam times, higher dose, and less effective outcomes. Further, the multiplicity of systems brought together in the procedure room may lead to an inefficient use of space in the room as well as a less than optimal layout with respect to the various systems and their utilization.

### BRIEF DESCRIPTION

In one embodiment, an interventional system is provided. The interventional system comprises a first platform comprising two or more imaging, monitoring, or tool navigation components. The two or more imaging, monitoring, or tool navigation components are configured to be used in contact with or in proximity to a patient. The interventional system further comprises a second platform in communication with the first platform. The second platform comprises processing, memory, and storage components. The second platform stores and executes routines for processing data acquired by the imaging, monitoring, or tool navigation components. The interventional system further comprises a third platform in communication with the second platform. The third platform comprises at least a user interface.

In a further embodiment, an integrated interventional system is provided. The integrated interventional system comprises two or more imaging subsystems in communication with a network. The imaging subsystems are configured to acquire image data during an examination or procedure and to publish the acquired image data in accordance with a publication/subscription communication protocol. The imaging subsystems each comprise one or more components configured for use in proximity to a patient that are provided as part of an integrated platform. The integrated interventional system also comprises a user interface subsystem in communication with the network. The user interface subsystem publishes control signals to one or more component subsystems and subscribes to receive the image data in accordance with the publication/subscription protocol.

In an additional embodiment, a consolidated interventional system is provided. The consolidated interventional system comprises a procedure room platform comprising two or more imaging, monitoring, navigational, or therapy subsystems, each comprising data generation components configured to be used on or proximate to a patient. The consolidated interventional system further comprises a server room platform comprising executable modules which, when executed, facilitate receipt of data from and control of the two or more imaging, monitoring, navigational, or therapy subsystems of the procedure room platform. The consolidated interventional system also comprises a user interface platform comprising at least a user interface configured to receive user inputs for operating at least the server room platform. The user interface platform, in some embodiments, may be provided as part of a control room aspect of the system.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts a block diagram of various systems using a shared display in an interventional context;

FIG. 2 depicts various components that may be present in an ultrasound system;

FIG. 3 depicts various components that may be present in an electrical monitoring system;

FIG. 4 depicts various components that may be present in an X-ray imaging system;

FIG. 5 depicts a generalized integrated system incorporating various subsystems for use in an interventional context, in accordance with aspects of the present disclosure;

FIG. 6 depicts the use of a point-to-point communication architecture with the integrated system components of FIG. 5, in accordance with aspects of the present disclosure; and

FIG. 7 depicts the use of a publish/subscribe communication architecture with the integrated system components of FIG. 5, in accordance with aspects of the present disclosure.

### DETAILED DESCRIPTION

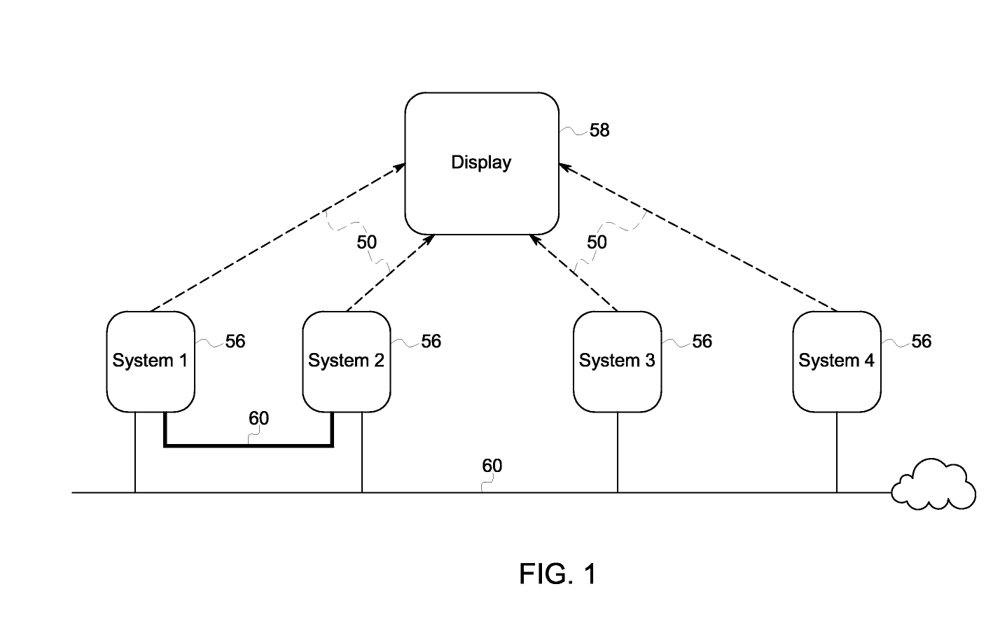

Modern interventional and surgical medical procedures may bring together a wide variety of monitoring, imaging, and therapy devices to facilitate the performance of these complex medical procedures. As a result, current procedure rooms typically contain a multiplicity of nominally free-standing systems that operate independent of one another and that are brought together to meet the specific needs of a particular procedure. For example, turning to FIG. 1, a conventional arrangement of systems 56 is depicted, each of which may contain their own display apparatus. The systems 56 may include imaging modalities (e.g., X-ray based imaging systems, ultrasound imaging systems, and so forth), interventional tracking systems (e.g., for tracking position and/or orientation information of interventional or surgical tools), and monitoring equipment (e.g., intravascular electrical monitoring, electrocardiograph (ECG) equipment, or respiratory monitoring systems)).

In the depicted example, video outputs 50 of each system 56 may be consolidated, such as through the use of a video switch that allows the display of data from multiple system modalities 56 onto a single screen 58 or several screens. That is, consolidation of information and images is generally via video integration of the outputs of several distinct and separately operating systems 56, with multiple cable paths connecting the separate pieces of equipment to one or more common or shared display devices 58.

Network connectivity 60 may be provided, but generally independently for each separate system modality 56 to a PACS or hospital network. Such an architecture, based on the ad hoc replacement or addition as new systems 56 become available, results in part from the independent development and incorporation of such systems 56. As a result, in such an implementation the various system modalities 56 operate, and communicate, independent of one another, even though the respective video outputs of each system modality may be aggregated for either separate or switchable display at a central site, e.g., tableside display 58. In this arrangement, the user interactions with the various systems 56 are only lightly integrated, if at all.

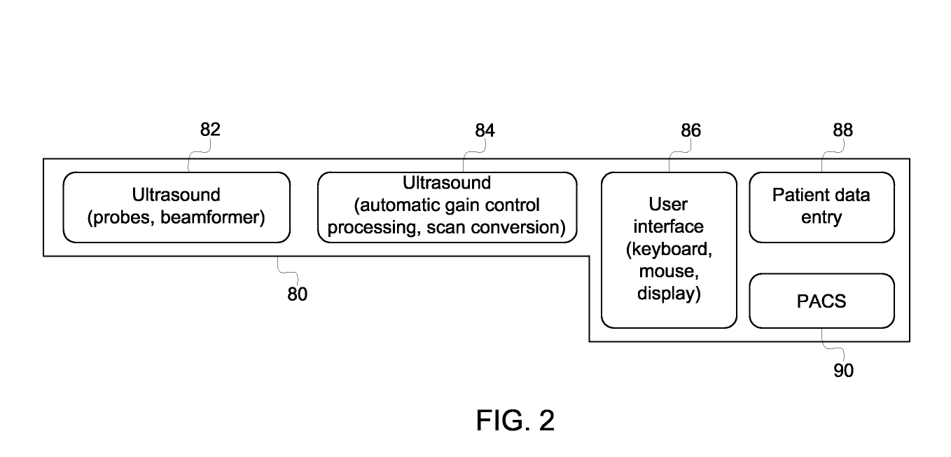

By way of example, FIG. 2 depicts a set of elements that may be found in a conventional ultrasound imaging system 80 suitable for use in an interventional procedure. In practice, the ultrasound system 80 may be provided as a standalone or independent system, such as on a movable cart, that may be moved close to or away from the procedure area as needed. Though, as discussed herein with respect to various embodiments, the various respective components of the ultrasound system 80 may actually, according to their function and operation, be situated in more suitable environments.

In FIG. 2, these various components of the ultrasound system 80 are depicted, including components 82 (such as an ultrasound probe and beamforming elements) that by necessity are present in the procedure room as they are used to interact with the patient tissues to form images. In addition, the ultrasound system 80 may also include various signal or data processing components 84 that may be present in the procedure room in a standalone ultrasound system, but which do not actually have to be present in the procedure room to perform their functions. That is, such signal or data processing components 84 are in communication with the procedure room components 82, but do not have to be present in the procedure room themselves (e.g., in a distributed implementation) to perform their function (unlike the procedure room components 82). For example, the signal or data processing components 84 may be in a technical room or equipment room or in a control room where user interface components of the ultrasound system 80 are present. With this in mind, the ultrasound system 80 may include a user interface 86, a patient data entry station or communication link 88, and/or link to a picture archiving and communication system (PACS) 90. Such components may allow a user to control operation of the ultrasound system 80, to initialize or utilize the ultrasound system 80 for a given patient, and/or to review or stored image data acquired by the ultrasound system 80. Such components that are used and/or operated by the user may be present in a control room or other room provided for user interface operations.

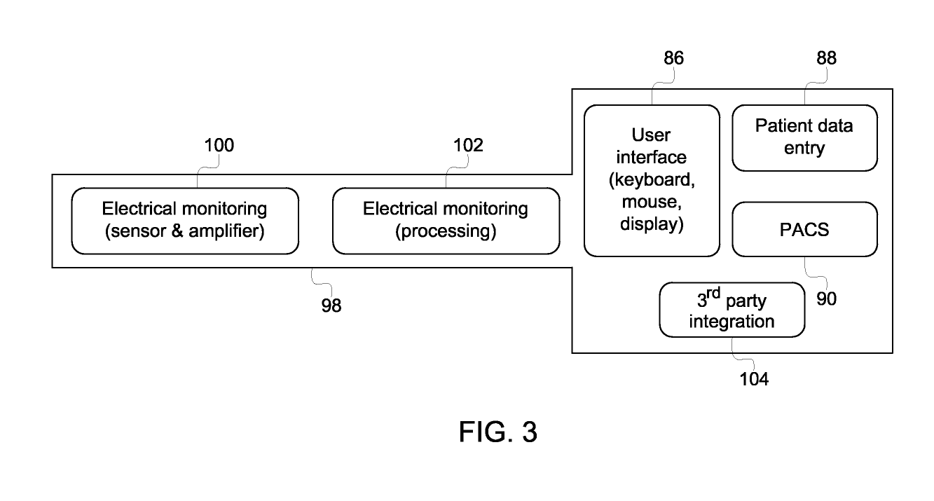

Similarly, in FIG. 3 various components of an electrical monitoring apparatus 98 (e.g., a catheter-based (i.e., intravascular) electrical sensor system, ECG system, or EEG system) are depicted, including components 100 (such as one or more sensing electrodes configured for internal or external placement on the patient, readout circuitry, and amplifiers) that are present in the procedure room due to a need for these components to be proximate to the patient. In addition, the electrical monitoring apparatus 98 may also include various signal or data processing components 102 that may be present in the procedure room in a standalone monitoring system, but which do not have to be present in the procedure room in a distributed implementation. That is, such signal or data processing components 102 are in communication with the procedure room components 100, but do not have to be present in the procedure room themselves to perform their function (unlike the procedure room components 100). For example, the signal or data processing components 102 may be in a technical room or equipment room or in a control room. Similarly, the electrical monitoring apparatus 98 may include a user interface 86, a patient data entry station or communication link 88, a link to a picture archiving and communication system (PACS) 90, and/or a 3^{rd} party integration component 104 (such as for providing monitored electrical data or signals to an imaging modality for use in an image acquisition or processing operation). Such components may allow a user to control operation of the electrical monitoring apparatus 98, to initialize or utilize the electrical monitoring apparatus 98 for a given patient, and/or to review or store signals or traces acquired by the electrical monitoring apparatus 98. Such components that are used and/or operated by the user may be present in a control room or other room provided for user interface operations.

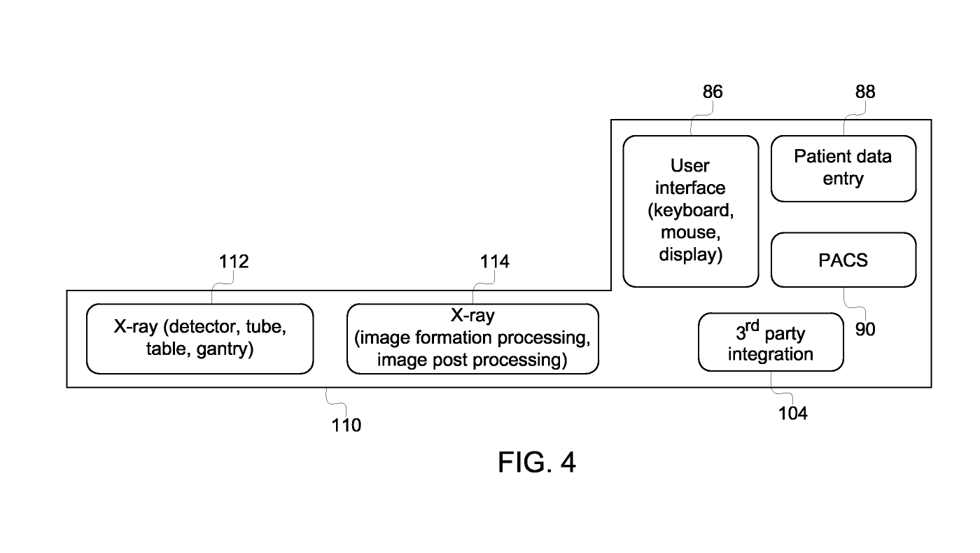

Further, in FIG. 4 various components of an X-ray imaging system 110 (e.g., a fluoroscopy, C-arm, tomosynthesis, or computed tomography (CT) imaging system) are depicted, including components 112 (such as an X-ray tube, detector, patient table, and gentry) that are present in the procedure room due to a need for these components to be proximate to the patient. In addition, the X-ray imaging system 110 may also include various control and processing components 114, (e.g., system controllers, motor controllers, X-ray tube controllers, signal or data processing circuitry) that may be present in the procedure room in a standalone X-ray imaging context, but which do not have to be present in the procedure room in a distributed implementation. That is, such control and processing components 114 are in communication with the procedure room components 112, but do not have to be present in the procedure room themselves to perform their function (unlike the procedure room components 112). For example, the control and processing components 114 may be in a technical room or equipment room or in a control room. Similarly, the X-ray imaging system 110 may include a user interface 86, a patient data entry station or communication link 88, a link to a picture archiving and communication system (PACS) 90, and/or a 3^{rd} party integration component 104 (such as for integrating operation of the X-ray imaging system 110 with other systems). Such components may allow a user to control operation of the X-ray imaging system 110, to initialize or utilize the X-ray imaging system 110 for a given patient, and/or to review or store images acquired by the X-ray imaging system 110. Such components that are used and/or operated by the user may be present in a control room or other room provided for user interface operations.

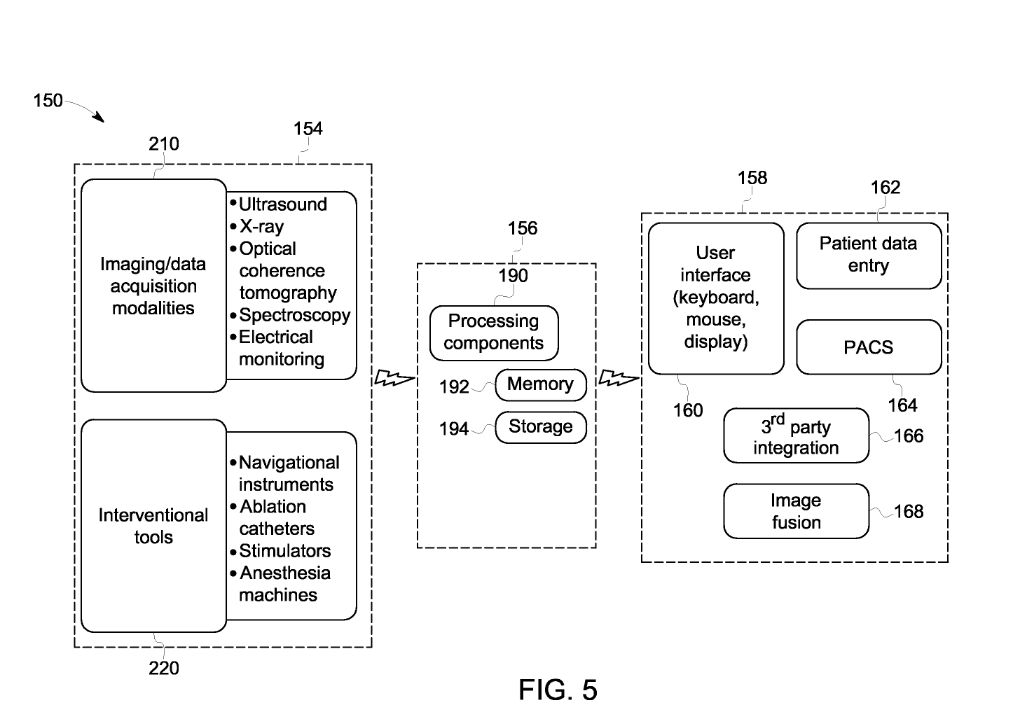

With the foregoing specific examples in mind of specific types of devices that may be present and used in interventional or therapeutic contexts, an integrated system approach (FIG. 5) is discussed that avoids duplication of architecture and consolidates system design (hardware and/or software) to better support an interventional or surgical implementation. For example, in one embodiment, the various functionalities of various separate standalone systems (such as those noted above) may be provided in a single integrated system 150 (e.g., as separate imaging or interventional subsystems of a larger integrated system). In such an implementation, various components of the integrated system 150 may be situated at different, suitable locations in the operating or surgical site.

The preceding examples related to specific technologies or modalities, and their constituent components, that may be present in an interventional, therapeutic, surgical or navigational context. In contrast, FIG. 5 depicts a generalized integrated system 150 that may incorporate the functionality of not only the prior examples of different modalities and systems, but also various other types of systems not previously discussed. For example, the integrated system 150 may generally include or support a variety of imaging and monitoring modalities 210. Examples of monitoring or imaging modalities that may be present or supported include, but are not limited to ultrasound imaging, X-ray imaging (fluoroscopy, mammography, C-arm angiography, computed tomography, tomosynthesis, and so forth), optical coherence tomography, spectroscopy, electrical monitoring (invasive or catheter-based and/or external), and so forth. Likewise, the integrated system 150 may generally include or support a variety of interventional tools or systems 220 that may be used in various interventional or therapeutic contexts, such as surgical or navigational implementations. Examples of such interventional tools include, but not limited to, navigational instruments and tracking, catheters (such as ablation catheters or probes for intravascular ultrasound) that may be inserted and operated within a patient, stimulators, anesthesia machines, and so forth.

Those components of the various interventional, monitoring, and imaging modalities that are integrated in the system 150 and that are necessarily present near the patient (i.e., in the procedure or surgical room) may be provided as part of an integrated console or platform (e.g., a patient examination or procedure platform 154) within the surgical or procedure room. For example, in the depicted implementation, the in-procedure room components of the integrated system 150 may be provided as a combined or integrated platform 154 having built-in the components needed to physically interact with the patient based on the supported modalities. That is, the combined or integrated patient procedure platform 154 may include, in a consolidated or integrated fixture, platform, or cart, those components needed by the various imaging, monitoring or interventional modalities to be within the procedure room in proximity to the patient.

Conversely, some or all of those components that do not need to be in the procedure room, or at least which do not need to be in proximity to the patient, may be provided in a separate, integrated platform (e.g., processing platform 156) that may be in communication with, but separate from, the patient procedure platform 154. For example, the processing platform 156 may be provided in a separate room (e.g., a technology or server room) or in a portion of the procedure room that is removed from the patient. In one embodiment, the processing platform 156 provides processing and/or control functionality (including image formation and processing functionality) to the components of the patient procedure platform 154, such as to provide control signals to the components of the patient procedure platform 154 and/or to process signals acquired by the components of the patient procedure platform 154.

As will be appreciated, in such an integrated platform, processing circuitry 190 (e.g., general processing components), memory circuitry 192, storage hardware 194, and so forth, may be shared to reduce or eliminate duplication of components and to allow for consolidation into a single server or processing piece. For example, in such implementations, shared processing components 190 (e.g., one or more general or special purpose processors), memory 192 or storage components 194 (e.g., memory chips or circuits, hard drives, solid state drives, optical media and readers, and so forth), and communication components (e.g., network connections, cables, wires, and so forth) may be used to implement various software modules that support the different functionalities provided by the integrated patient procedure platform 154 and processing platform 156.

For example, one or more ultrasound software modules (i.e., ultrasound application routines) may be executable on the shared hardware components of the processing platform 156 to both drive or control the operation of the ultrasound components present in the procedure room (i.e., on the patient procedure platform 154) and/or to receive or process the data generated by the ultrasound components present in the procedure room. Similarly, one or more electrical monitoring software modules or routines, X-ray software modules or routines, and/or navigational or tracking system software modules or routines may also be executable on the shared hardware components of the processing platform 156 to drive or control the respective operation of the corresponding components present in the procedure room and/or to receive or process the data generated by the corresponding components present in the procedure room. Such modules or routines for implementing the various modalities supported by the patient procedure platform 154 and processing platform 156 may be simultaneously executable on the processing platform 156 (i.e., may run in parallel) or may be switched between if running in a non-parallel implementation. Examples of such software modules or routines include, but are not limited to, image or data acquisition, image processing, image display or visualization, image segmentation and measurement, image registration, image fusion, PACS communication, and so forth.

To the extent that certain software functions or functionality is common to the respective modalities, the corresponding software modules or routines may be configured to provide that functionality to each of the respective modalities. For example, a single communication module or set of routines may be configured to support data or control signal transmission for each of the respective modalities instead of each supported modality having its own communication module or routines. Thus, in one implementation, both hardware and software components of the integrated system may be generalized and shared to support multiple imaging and navigation systems used in a surgical or interventional context.

As will be appreciated, the present approach also provides the benefit that, as new modalities or instrumentation is added to the integrated patient procedure platform, support for such new modalities may be added to the processing platform 156 by loading or adding new or appropriate software modules or routines. In one implementation, the new devices may be automatically recognized or discovered by the system and/or automatically configured for use within the larger interventional suite. In this manner, new capabilities may be automatically enabled or allowed by the introduction of the new instrument to the system. In this manner, support for new or additional modalities may be easily integrated or supported in a consolidated platform, without having separate carts or consoles having to be present in the procedure or technical rooms.

The consolidated platform of FIG. 5 may also include a user interface platform or piece 158 that may be used to support the various modalities or navigational components used in the procedure room. For example, in the depicted embodiment a user interface platform 158 includes a user interface station 160 (e.g., keyboard, mouse, and display) that may be used to operate or otherwise communicate with or support each of the imaging or navigation modalities. This is in contrast to a situation in which each of the supported imaging or navigation modalities is provided as a standalone system, having its own user interface console with supporting hardware and software. In this manner, user interface hardware and software may be consolidated and duplication of hardware and software modules avoided. In one embodiment, the user interface platform 158 may be provided in a room separate from one or both of the patient procedure platform 154 and processing platform 156, such as in a control room. However, in other implementations, the user interface platform may be provided in the same room or location as one or both of the patient procedure platform 154 and processing platform 156 (e.g., in a procedure room or technical room) and/or may itself be integrated or consolidated with one or both of patient procedure platform 154 and processing platform 156.

In addition to the depicted user interface station 160, the user interface platform or piece 158 may include other components or systems, such as patient data entry interface 162 (such as a communication link for querying or updating a patient database), a communication link for querying or updating a picture archiving and communication system (PACS) 164, third-party integration components 166, and/or image fusion components 168. As discussed above, in certain implementations, such components of the user interface platform 158 may be consolidated or optimized to share common hardware components and/or software modules or routines to facilitate the user interface and/or communication functions provided by the user interface platform 158.

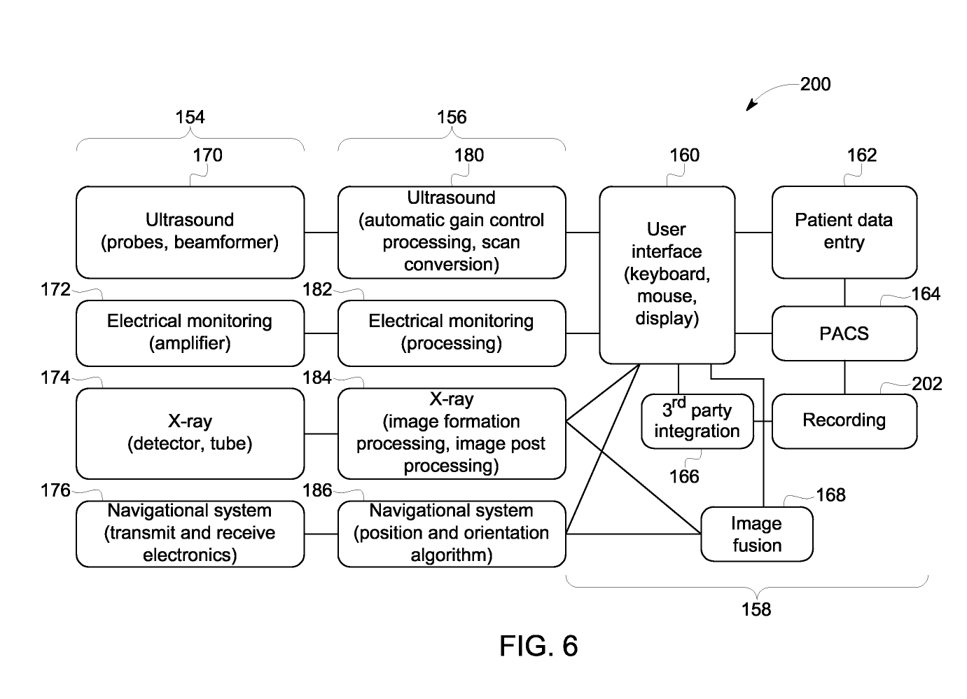

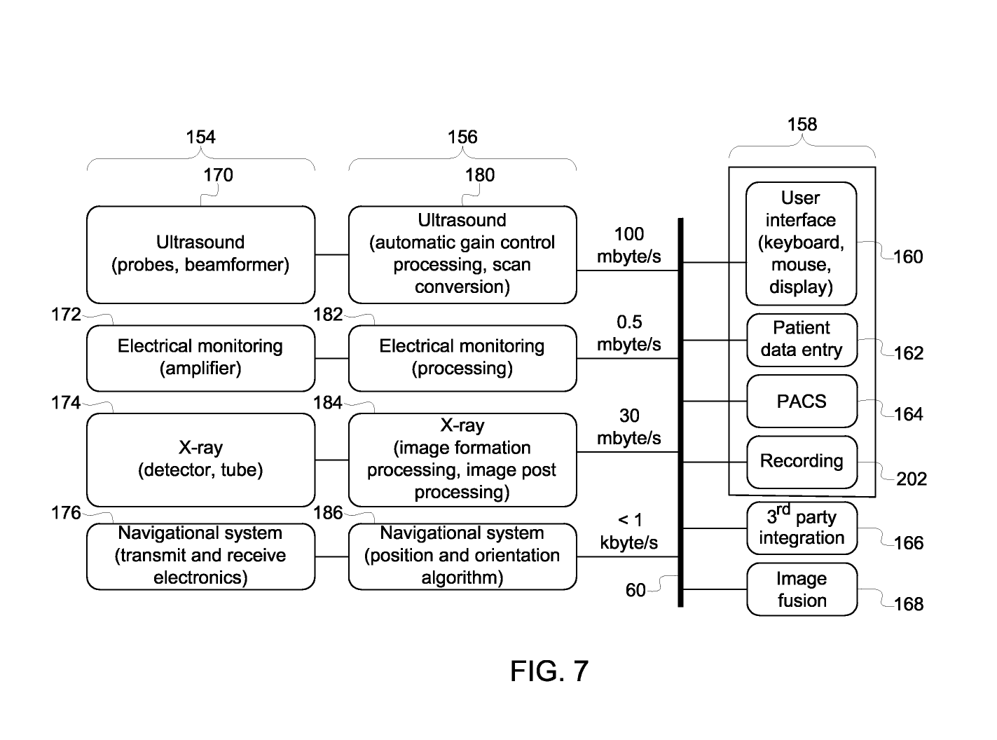

With the foregoing in mind, data and control signals can be communicated between components of the integrated system 150 in various manners. For example, in accordance with the present disclosure, both point-to-point (e.g., client-server) and publish-subscribe models could be used for consolidating data and/or control signals, as could other suitable approaches. Further, ad hoc methods customized for specific devices and connections (components, subsystems, systems) could also be employed. A conceptual overview of the point-to-point based approach is shown in FIG. 6, while a publish-subscribe model based approach is shown in FIG. 7.

Turning to FIG. 6, in the depicted example a point-to-point architecture is depicted to allow consolidated communication between the components of the consolidated system 150. In this example, the system 150 is depicted as including an ultrasound modality, an electrical monitoring modality, an X-ray modality, and a navigational system modality. Based on this example, the respective ultrasound components 170 within the patient procedure platform 154 (e.g., probes and beamformer circuitry) directly communicate with the corresponding ultrasound components or modules 180 within the processing platform 156 (e.g., automatic gain control (AGC) processing and scan conversion circuitry).

For example, the patient procedure platform 154 in the depicted example also includes electrical monitoring components 172 (e.g., electrodes and amplification circuitry), X-ray components 174 (e.g., tubes or other sources, detectors, and gantry or C-arm hardware), and/or navigational sensor components 176 (e.g., transmitters, receivers, and so forth used to track a surgical or interventional instrument). These respective components in the patient procedure platform 154 may correspondingly communicate with the corresponding components or modules within the processing platform 156 (e.g., processing circuitry 182 for supporting electrical monitoring, controllers and/or processing components 184 suitable for supporting X-ray components, and/or navigational system processing components 186 (e.g., position and orientation algorithm circuitry). As will be appreciated, the described components are only example. In other implementations other modalities and systems may be supported in the patient procedure and processing platforms.

The various processing components or modules of the processing platform 156 may, in this example, communicate with the user interface 160. The user interface 160 may in turn communicate with other functionality of the user interface platform 158, such as the patient data entry interface 162, PACS 164, 3^{rd} party integration module 166, or image fusion module 168. Further, certain of the processing components or modules of the processing platform 156 may communicate with other modules or components of the user interface platform 158, such as (in the depicted example, the X-ray modality 184 and navigation system 186 both communicating with the image fusion module 168, which may include estimation and image generation routines what access one or more imaging feeds and output other imaging or parameters (e.g. transformations) to use in visualizations. Similarly, certain of the processing components or modules of the user interface platform 158 may communicate with other modules or components of the user interface platform 158, such as the PACS 164 and 3^{rd} party integration module 166 communicating with a recording module 202 in the depicted example.

While FIG. 6 depicts a generalized point-to-point or client-server type approach for interconnection of components of an integrated system, FIG. 7 depicts an alternative architecture based on publish/subscribe connectivity. In the depicted example, the patient procedure platform 154 components communicate with the corresponding components or modules of the processing platform 156. The respective components or modules of the processing platform 156 may in turn communicate with a network backbone 60 to which the various modules and components of the user interface platform 158 are also in communication.

In such a publish/subscribe architecture, various components may publish data, control signals or updates generated by the respective components and which is delivered to other components which are configured to receive such data, control signals, or updates as they become available (i.e., subscribers). For example, the 3^{rd} party integration module 166 may be designated as a subscriber to data or updates published by the X-ray modality and navigation system. Thus, as new X-ray image and navigation tracking data becomes available, this data may be delivered to the 3^{rd} party integration module 166, or to any other module of the user interface platform 158 specified as subscribing to receive such imaging or tracking updates. Likewise, the user interface components 160, patient data entry interface 162, PACS 164, recording module 202, and/or image fusion module 168 may be designated as subscribers to receive data or updates published by the respective imaging or monitoring modalities and/or as publishers to publish control signals to other components. For example, the image fusion module 168 may include estimation and image generation routines and may subscribe to the imaging feeds and publish either other imaging or parameters (e.g. transformations) to use in visualizations. In addition, one or more of the user interface components 160 may publish commands or instructions to the processing and/or procedure room components, such as to synchronize the start of an image or data acquisition or to configure such an acquisition. In such an example, the processing or procedure room components would in turn be subscribers to such commands while also being publishers of the acquired data.

Such an architecture may provide greater flexibility than other architectures, such as the point-to-point architecture, as the modules that publish and/or subscribe to particular control signals or data may be configured and changed as dictated by the situation. By way of example, unusual or unexpected data flows may be accommodated easily simply by designating a given component as a subscriber to the desired data. For example, in certain instances data or images generated using one modality may be displayed on a screen or output device associated with another modality. Thus, X-ray images could be displayed on the ultrasound screen, simply by making that display a subscriber to the X-ray data. Such an implementation may be helpful to a technician performing an echocardiogram who might otherwise not be able to see the X-ray display from the ultrasound station in the procedure room.

Technical effects of the invention include the elimination of duplicate equipment or components in an interventional suite. Further technical effects include the consolidation of image formation and processing functions in an interventional suite and the ability to group elements with like requirements (e.g., in the procedure room). Other technical effects include the elimination of the need for multiple connecting cables, etc. due to the consolidation of hardware and functions in an interventional suite. Business advantages include easier engineering of system upgrades, simplified validation and verification of the system in product development, and reduced system cost due to elimination of duplicate equipment. Clinical advantages include simplified user interaction with the system due to consolidation of components into a single system or interface, significant clutter reduction in the procedure room and the control room, and potentially better workflow, faster procedures, and better outcomes due to more highly integrated information.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An interventional system, comprising:
a first platform comprising two or more imaging, monitoring, or tool navigation components, wherein the two or more imaging, monitoring, or tool navigation components are configured to be used in contact with or in proximity to a patient;
a second platform in communication with the first platform, the second platform comprising processing, memory, and storage components, wherein the second platform stores and executes routines for processing data acquired by the imaging, monitoring, or tool navigation components; and
a third platform in communication with the second platform, wherein the third platform comprises at least a user interface.

2. The interventional system of claim 1, wherein the first platform is placed in a patient procedure room.

3. The interventional system of claim 1, wherein the second platform is placed in a separate room from the first platform.

4. The interventional system of claim 1, wherein the second platform is placed in a server room.

5. The interventional system of claim 1, wherein the second platform comprises a server having processing, memory, and storage components and configured to communicate with the first platform.

6. The interventional system of claim 1, wherein the third platform is placed in a control room.

7. The interventional system of claim 1, wherein the user interface comprises one or more of a keyboard or mouse for receiving user inputs and a display for displaying information to a user.

8. The interventional system of claim 1, wherein the third platform further comprises one or more of a patient data entry interface or a PACS interface.

9. The interventional system of claim 1, wherein the third platform further comprises one or more modules for image recording, image fusion, or 3rd party integration.

10. The interventional system of claim 1, wherein the first platform, the second platform, and the third platform exchange data using a publication/subscription communication protocol.

11. An integrated interventional system, comprising:
two or more imaging subsystems in communication with a network, wherein the imaging subsystems subscribes to control signals controlling acquisition of image data during an examination or procedure and publishes the acquired image data in accordance with a publication/subscription communication protocol;
wherein the imaging subsystems each comprise one or more components configured for use in proximity to a patient that are provided as part of an integrated platform; and
a user interface subsystem in communication with the network, wherein the user interface subsystem publishes the control signals to one or more component subsystems and subscribes to receive the image data in accordance with the publication/subscription protocol.

12. The integrated interventional system of claim 11, further comprising a navigational subsystem in communication with the network, wherein the navigational subsystem acquires at least position information for a tracked tool during an examination or procedure and publishes the acquired position information to the user interface subsystem in accordance with the publication/subscription communication protocol;

13. The integrated interventional system of claim 11, wherein the two or more imaging subsystems comprise, one or more of an ultrasound subsystem or an X-ray based imaging subsystem.

14. The integrated interventional system of claim 11, further comprising an electrical monitoring subsystem in communication with the network, wherein the electrical monitoring subsystem acquires electrical signal data during a procedure and publishes the acquired electrical signal data in accordance with the publication/subscription communication protocol.

15. The integrated interventional system of claim 13 further comprising an image fusion subsystem in communication with the network, wherein the image fusion subsystem subscribes to receive the image data and the navigational tracking data in accordance with the publication/subscription protocol.

16. A consolidated interventional system, comprising:
a procedure room platform comprising two or more imaging, monitoring, navigational, or therapy subsystems, each comprising data generation components configured to be used on or proximate to a patient;
a server room platform comprising executable modules which, when executed, facilitate receipt of data from and control of the two or more imaging, monitoring, navigational or therapy subsystems of the procedure room platform; and
a user interface platform comprising at least a user interface configured to receive user inputs for operating at least the server room platform.

17. The consolidated interventional system of claim 16, wherein the navigational subsystem comprises at least one of transmit and receive electronics for tracking an interventional tool.

18. The consolidated interventional system of claim 16, wherein the user interface platform displays patient information, images, or data processed by the server room platform.

19. The consolidated interventional system of claim 16, wherein the procedure room platform, the server room platform, and the user interface platform exchange data using a publication/subscription communication protocol.

20. The consolidated interventional system of claim 16, wherein at least one of the two or more imaging, monitoring, or therapy subsystems comprise an ultrasound probe.

21. The consolidated interventional system of claim 16, wherein the two or more imaging, monitoring, or therapy subsystems comprise at least an X-ray source and a detector.

22. The consolidated interventional system of claim 16, wherein the user interface publishes control signals that are subscribed to by one or more modules of the procedure room platform or the server room platform in accordance with a publication/subscription protocol to configure or initiate operation of a respective subsystem.
